(19) United States
(12) Patent Application Publication
(10) Pub. No.: US 2021/0310299 A1
(43) Pub. Date: Oct. 7, 2021

(54) BOTTOM RAIL BAR CONNECTABLE TO A SHADE IN DIFFERENT OPERATIVE ORIENTATIONS

(71) Applicant: EDWIN CHIQUIN, MIAMI, FL (US)

(72) Inventor: EDWIN CHIQUIN, MIAMI, FL (US)

(21) Appl. No.: 16/839,715

(22) Filed: Apr. 3, 2020

(51) Int. Cl. E06B 9/42

(52) U.S. Cl. CPC E06B 9/42

(57) ABSTRACT

A bottom rail for a flexible material shade including an elongated base dimensioned and configured to be connected to the shade. The base has a hollow interior, extending along the length thereof, and including a plurality of cavities extending interiorly along the length of the base. The plurality of cavities are symmetrically disposed relative to a major axis of the base and are cooperatively structured with the base to be connected to a free end of the shade in different operative orientations, methods styles, etc.

### BACKGROUND OF THE INVENTION

### Field of the Invention

This invention is directed to a bottom rail including, but not limited to, a bottom rail hem bar for a roller type, flexible material roller shade having an elongated configuration and a hollow interior. The hollow interior comprises a plurality of cavities cooperatively structured with the remainder of the base to facilitate connection thereof to a free end of the shade in a plurality of different operative orientations, styles and/or methods.

### Description of the Related Art

Window treatments of various types are used both domestically and commercially throughout most industrialized countries of the world. Such known and/or conventional window treatments include, but are not limited to, drapes, curtains, shutters, blinds, shades, etc.

Perhaps one of the oldest forms of window treatment includes shade structures, or more specifically roller shades, comprising a flexible material fabric, film, etc. initially stored in surrounding relation to a supporting, cylindrical roller. The roller is rotationally mounted generally at the top end or edge of the window and the flexible material shade is rolled downwardly, from the supporting roller, into covering relation with the window. The shade, when in its operative, shading orientation is generally dimensioned to cover substantially the entirety of the window for purposes of restricting light and viewing through the window.

The popularity of such roller shades is due, at least in part, to their comparatively low cost, ease of operation and effectiveness in providing the desired or required amount of shade. Further the flexible shade material utilized can vary significantly in both size, configuration and decorative features.

Other features incorporated within such a conventional roller shade or otherwise usable therewith is the ability to further restrict light passing through the window by movably positioning the edges of the shade into side channels connected to or integrated within the longitudinal sides of the window frame. When such side channels are used, light is prevented or significantly restricted from passing between the opposite longitudinal edges of the flexible material shade and the correspondingly disposed sides of the window frame.

Additional structural and operative features associated with this type of window treatment including the use of a bottom rail or weight bars dimensioned and structured to be connected to a bottom free end and/or edge of the shade. The bottom rail is utilized help extend the shade and extend or, remove any wrinkles in the fabric, thereby positioning it in its intended overlying, covering and shading orientation relative to at least a majority of the window.

The popularity of roller type shades have also led to various types of the bottom rails. Accordingly, bottom rails for flexible material shades may vary in size, configuration and weight. However, one problem associated with the utilization of conventional bottom rails is that each may differ in the manner in which it is operatively connected to the free end of the shade. As a result, a user of such roller shade type window treatment may have to completely replace the bottom rail of a given shade structure if the type of operative connection to the free end of the shade is no longer desired or structurally appropriate.

Therefore, there is a need in the art and industry associated with window treatments and in particular flexible material roller shade structures, for a bottom rail which overcomes the disadvantages and problems of the type set forth above. In more specific terms, a proposed and improved bottom rail would be structured to assume different operative orientations by virtue of different types of attachments or connections to the free end of the flexible material shade. Further, an improved bottom rail structure would preferably be dimensioned and configured to assume any one of a plurality of different operative orientations in a stable and reliable manner. Also, if a change in the operable orientation of the improved bottom rail is desired or required, it can be easily accomplished without requiring a replacement thereof for a bottom rail having different structural and operative features.

### SUMMARY OF THE INVENTION

The present invention is directed to a bottom rail for a roller shade assembly of the type including a flexible material shade member positioned in a rolled configuration about a support roller and which is typically includes a clutch, a spring or a motor and is disposed at the top end of a window being treated.

As set forth in greater detail hereinafter, the structural and operative features of the bottom rail allow it to be connected to the bottom free end of the flexible shade in any one of a plurality of operative orientations. This structural versatility allows the same bottom rail to be attached in different ways to the free end of the shade material thereby individually defining different operative orientations when so connected.

In more specific terms, the bottom rail includes an elongated base dimensioned and configured to be connected to the free end of the shade and having a length sufficient to extend along substantially the entirety of the transverse dimension of the flexible material shade. Further, the base may be formed by extrusion from a plastic, aluminum or other appropriate material and as such has an at least partially hollow interior extending along the length thereof.

The hollow interior comprises and/or is defined by a plurality of cavities all or at least some of which extend along substantially the entirety of the length of the hollow interior, due at least in part to the extruded formation of the base. Also, the base includes an elongated slot or channel-like opening formed preferably in an upper peripheral portion of the base and extending along substantially the entirety of the base. This opening communicates with the hollow interior of the base and is disposed and dimensioned to facilitate passage of the free end of the shade into the hollow interior, dependent on the operative orientation, style, method, etc. of the base/bottom rail when connected to the shade.

In at least one preferred embodiment, the plurality of cavities disposed within an at least partially defining the hollow interior include a retainer cavity, a connector cavity and at least one, but preferably two receiving cavities. Moreover, the retainer cavity is structured to receive a retainer therein. The retainer may be in the form of an elongated retaining rod, which may be disposed in retaining engagement with at least a portion of the free end disposed within the hollow interior as the free end passes through the aforementioned elongated channel or opening. Additional features of the retainer may include the forming of the elongated retaining rod from a variety of different materials. As a result, additional weight, when desired or required, may be added to the bottom rail by forming the retaining rod from a heavier metallic material rather than a lighter weight plastic material. When such a metallic or other heavier material is utilized, the retainer and/or retaining rod may be accurately described as including a weighted construction.

The aforementioned connector cavity is disposed, dimensioned and configured to receive, retain and removably engage a connector which serves to removably secure end caps to the different open end of the base, as described in greater detail hereinafter. As also more fully described, the intended versatile utilization of the bottom rail, includes a preferred overall configuration of the base and configuration and disposition of the plurality of cavities. Accordingly, the base may be formed into an elongated elliptical configuration having a major axis disposed in at least partial alignment with the flexible shade and its upward and downward direction of travel, when the base is connected thereto. In cooperation with the elongated elliptical configuration of the base, the plurality of cavities are collectively disposed in a symmetrical relation relative to the major axis of the elliptical base. Therefore, due to the configuration of the base and the symmetrical disposition of the plurality of cavities, the bottom rail will reliably demonstrate stability in its location and/or position, when attached to the bottom free end of the shade material. Also, the elongated elliptical configuration of the base may allow it to be fitted within many, if not most, existing side rails of window frames being shaded.

For purposes of clarity, at least one embodiment of the base, specifically including the plurality of cavities, comprises the inclusion of one retainer cavity and one connector cavity which may be disposed and/or interconnected to one another in close proximity. However, the interior portions of the retainer and connector cavities are segregated in order to avoid a wrongful attachment of the aforementioned end cap to a correspondingly disposed open end of the base.

The collective symmetrical disposition of the plurality of cavities is further defined by the inclusion of two opposed receiving cavities disposed on opposite sides of and in equally spaced relation to the major axis of the elliptically shaped base and hollow interior. Either of the receiving cavities are disposed, dimensioned and configured to receive a portion of the free end of the shade passing into the hollow interior through the aforementioned elongated peripheral opening or channel formed in a periphery of the base. The free end may be so disposed in a retaining engagement in one of the preferably two receiving cavities, dependent on the operative orientation of the bottom rail which defines a manner of attachment of the base/bottom rail to the free end of the flexible material shade.

Therefore, in at least one preferred embodiment the aforementioned collective symmetrical disposition of the plurality of elongated cavities, within the hollow interior, may be even more specifically defined by the major axis passing concurrently through the substantial center of both the retainer cavity and the connector cavity and between and in equally spaced relation to both of the preferably two opposed receiving cavities.

As set forth above, the base of the bottom rail may also include two end caps removably connected in covering relation to different ones of two oppositely disposed open ends of the base. The two end caps may be attached in the manner indicated to the base of the bottom rail, dependent at least in part, on the operative orientation of the base/bottom rail when connected to the free end of the shade. As such, the end cap comprises a plurality of fingers extending outwardly from an inner surface thereof. Each of the fingers are cooperatively disposed, dimensioned and configured to be telescopically received into a correspondingly dimensioned and/or configured spaces of the hollow interior and/or one or more of the plurality of cavities.

In at least one embodiment, a plurality of three fingers are secured to the inner surface of the end cap. At least one of the plurality of three fingers is dimensioned and configured to be telescopically received within an open space of the hollow interior located adjacent to the connector cavity. In cooperation therewith, two others of the plurality of three engaging fingers are disposed in spaced relation to one another at generally an upper end of the end cap and are angularly or otherwise oriented to be telescopically received within different ones of the receiving cavities. It is emphasized that the number, disposition, dimension and configuration of the plurality of fingers associated with the end cap may vary and still be considered within the spirit and scope of the present invention. In order to assure a fixed, stable but removable attachment of the end cap to one of the open ends of the base, a separate connector, such as a screw or the like, passes through an appropriate aperture in the end cap and into the aforementioned connector cavity. As a result, the connector may be removably threaded or otherwise removably make with the interior surface portions of the connector cavity.

Therefore, the bottom rail which could include, but not be limited to a bottom rail hem bar, includes a base with a preferred elongated elliptical shape, having a hollow interior including a plurality of collectively symmetrical cavities, all cooperatively structured to facilitate attachment to the free end of a shade in a plurality of different operative orientations, styles, methods, etc. Further by way of non-limiting example, the plurality of different operative orientations, styles, methods, etc. may include, but not be limited to, an external, exposed orientation; and enclosed hem bar orientation and a covered, wrapped orientation.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of a partially assembled bottom rail of the present invention in an unattached relation to a shade.

FIG. 2 is a perspective view in partially exploded form of an end cap removably connected to an open end of a base of the bottom rail of the embodiment of FIG. 1.

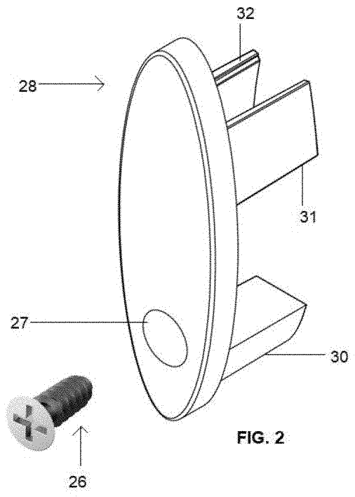

FIG. 3 is a perspective view in partial cutaway of the base and the end cap of the embodiments of FIGS. 1 and 2 respectively, in partially assembled form.

FIG. 4 is a perspective view of one of a possible plurality of operative orientations, methods, etc. of the bottom rail connected to a free end of the shade.

FIG. 5 is a perspective view of one other of a possible plurality of operative orientations, styles, methods, etc. of the bottom rail being connected within an interior of a pocket at the free end of the shade.

FIG. 6 is a perspective view of yet one other of a possible plurality of operative orientations, methods, styles, etc. of the bottom rail being wrapped about and to a free end of the shade.

Like reference numerals refer to like parts throughout the several views of the drawings.

### DETAILED DESCRIPTION OF THE PREFERRED EMBODIMENT

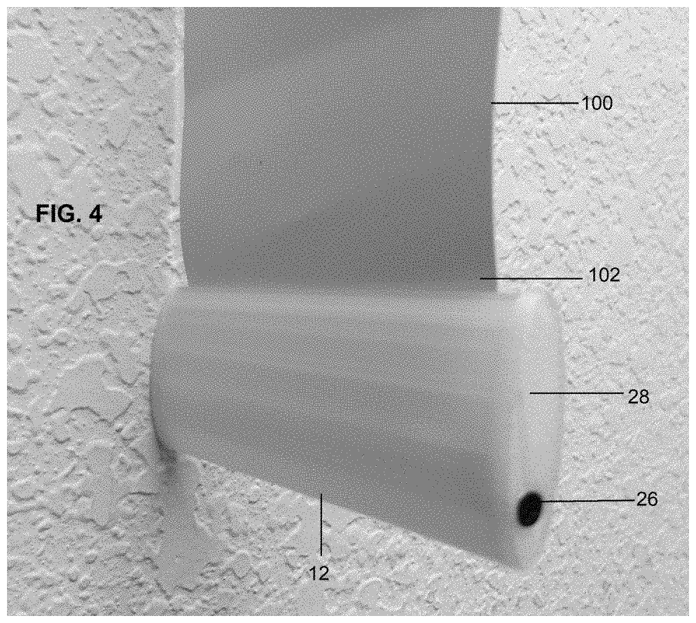

As represented in the accompanying Figures, the present invention is directed to a bottom rail, generally indicated as 10, for a roller shade assembly of the type including a flexible material shade 100, as represented in FIGS. 4-6. It is noted that the bottom rail 10 could include, but not be limited to, a bottom rail hem bar. In typical or conventional fashion, the shade member 100 is removably disposed in a rolled configuration, about a support roller (not shown for purposes of clarity). Operation of the roller shade assembly, in terms of positioning and removing it in overlying relation to a window being shaded is facilitated by the support roller typically being operated by a clutch, spring or motor and disposed at the top end of a associated window.

As set forth in greater detail hereinafter, the structural and operative features of the bottom rail allow it to be connected to the bottom free end of the flexible shade, generally indicated as 102, in any one of a plurality of operative orientations. As discussed in greater detail hereinafter with primary reference to FIGS. 4-6, this versatile structuring allows the bottom rail 10 to be attached in different ways to the free end 102 of the shade 100, thereby individually defining different operative orientations of the bottom rail 10 when so connected.

In more specific terms, the bottom rail 10 includes an elongated base 12 dimensioned and configured to be connected to the free end 102 of the shade 100. Further, the elongated base 12 has a length sufficient to extend along substantially the entirety of the transverse dimension of the flexible shade 100. Further, the base 10 may be formed by extrusion from a plastic, aluminum or other appropriate material and as such has an at least partially hollow interior 14 extending along the length thereof.

The hollow interior comprises and/or is defined by a plurality of cavities 18-20, all or at least some of which extend along substantially the entire length of the hollow interior 14, due at least in part to the extruded formation of the base 12. Also, the base 12 includes an elongated slot or channel-like opening 16 formed preferably in an upper peripheral portion 12′ of the base 12 and also extending along substantially the entire length of the base 12. This opening 16 communicates with the hollow interior 14, as well as at least some of the plurality of cavities 18-20, of the base 10. The elongated opening 16 is disposed and dimensioned to facilitate passage of the free end 102 of the shade member 100 into the hollow interior 14, dependent on the operative orientation of the base 12/bottom rail 10 when connected to the bottom or free end 102 shade member 100.

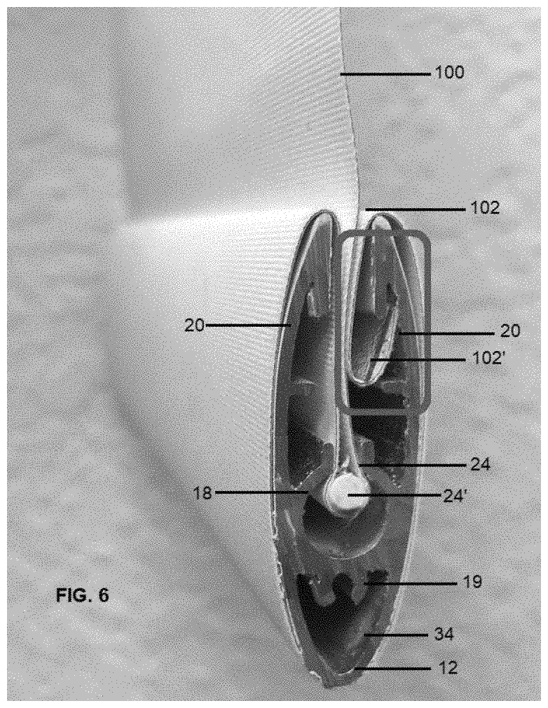

In at least one preferred embodiment, the plurality of cavities 18-20 disposed within an at least partially defining the hollow interior 14 include a retainer cavity 18, a connector cavity 19 and at least one, but preferably two receiving cavities each indicated as 20. Moreover, the retainer cavity 18 is structured to receive a retainer 24 therein. The retainer 24 may be in the form of an elongated retaining rod 24′, which may be disposed in retaining engagement with at least a portion of the free end 102 disposed within the hollow interior 14, as represented in at least FIG. 6. Disposition of the free end 102 of the shade member 100 with the retainer rod 24′ is accomplished by passing the free end 102 through the aforementioned elongated opening 16. Additional features of the retainer 24 may include the forming of the elongated retaining rod 24′ from a variety of different materials. As a result, additional weight may be added to the bottom rail 10, when desired or required, by forming the retaining rod 24′ from a heavier metallic material such as, but not limited to, steel, etc., rather than a lighter weight plastic material. When such a metallic or other heavier material is utilized, the retainer 24 and/or retaining rod 24′ may be accurately described as including a “weighted construction”.

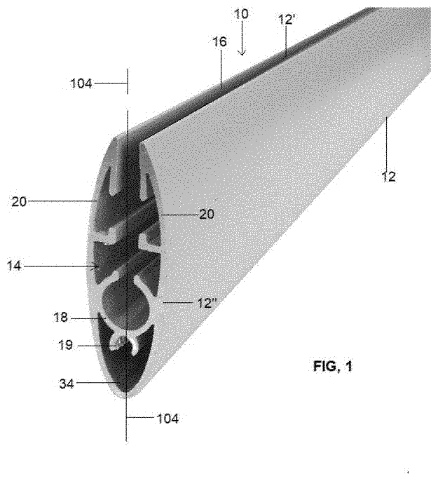

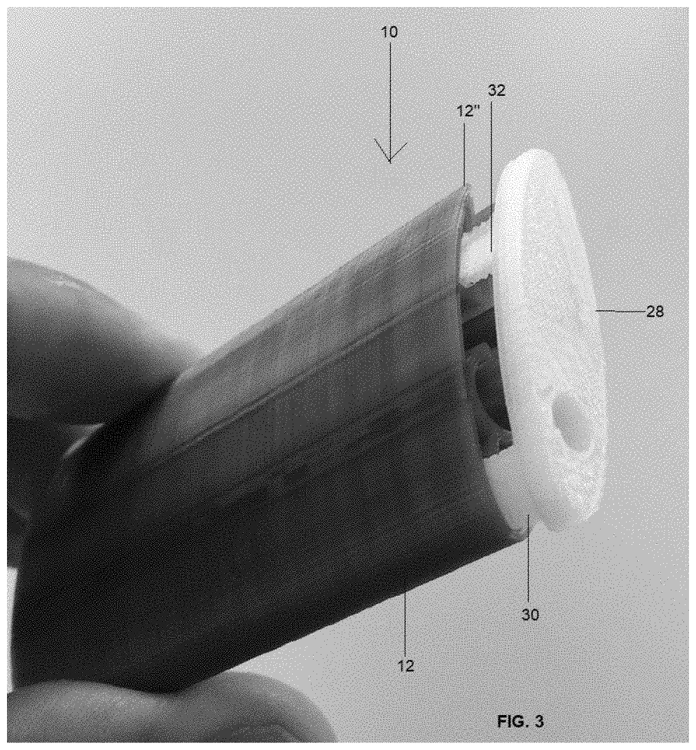

The aforementioned connector cavity 19 is disposed, dimensioned and configured to receive, retain and removably engage a connector 26 which serves to removably secure an end cap 28 to one or each open end 12″ of the base 12, as represented in at least FIG. 3 and described in greater detail hereinafter. As also more fully described, the intended versatile utilization of the bottom rail 10, includes a preferred overall configuration of the base 12 and configuration and disposition of the plurality of cavities 18-20. Accordingly, the base 12 may be formed into an elongated elliptical configuration having a major axis schematically represented at 104, as represented in at least FIG. 1. The major axis 104 is disposed in at least partial alignment with the flexible shade 100 and its upward and downward direction of travel relative to the aforementioned support roller (not shown), when the base 12 is connected thereto. In cooperation with the elongated elliptical configuration of the base 12, the plurality of cavities 18-20 are collectively disposed in a symmetrical relation relative to the major axis 104 of the elliptical base 12. Therefore, due at least in part to the elongated elliptical configuration of the base 12 and the symmetrical disposition of the plurality of cavities 18-20, the bottom rail 10 will reliably demonstrate stability when attached to the bottom free end 102 of the shade material 100, in any of the possible operative configurations of the bottom rail 10, as represented in FIGS. 4-6.

For purposes of clarity, at least one embodiment of the base 12, specifically including the plurality of cavities 18-20, comprises the inclusion of one retainer cavity 18 and one connector cavity 19, which may be disposed and/or interconnected to one another in close proximity, as clearly represented in FIG. 1. However, the interior portions of the retainer cavity 18 and connector cavity 19 are segregated in order to avoid a wrongful attachment of the aforementioned connector 26 and end cap 28 to a correspondingly disposed open end 12″ of the base 12.

The collective symmetrical disposition of the plurality of cavities 18-20 is further defined by the inclusion of two opposed receiving cavities each indicated as 20, disposed on opposite sides of and in equally spaced relation to the major axis 104 of the elliptically shaped base 12 and hollow interior 14. Either of the receiving cavities 20 is disposed, dimensioned and configured to receive an extremity 102′ of the free end 102 of the shade 100 passing into the hollow interior 14 through the aforementioned elongated peripheral opening or channel 16 formed in a periphery of the base 12, as represented in at least FIG. 6. The free end extremity 102′ may be so disposed in a retaining engagement in one of the preferably two receiving cavities 20, dependent on the operative orientation of the bottom rail 10 which defines a manner of attachment of the base 12 to the free end 102 of the shade 100.

Therefore, in at least one preferred embodiment the aforementioned collective symmetrical disposition of the plurality of elongated cavities 18-20, within the hollow interior 14, may be even more specifically defined by the major axis 104 passing concurrently through the substantial center of both the retainer cavity 18 and the connector cavity 19 and between and in equally spaced relation to both of the preferably two opposed receiving cavities 20, as represented in FIG. 1.

As set forth above, the base 12 of the bottom rail 10 may also include end caps 28. Each of the two end caps 28 is removably connected in covering, overlying relation to a different one of possibly two, oppositely disposed open ends 12″ of the base 12, in a manner represented in at least FIG. 3. As such, each of the end caps 28 comprise a plurality of fingers 30, 31 and 32, extending outwardly from an inner surface thereof. Each of the fingers 30-32 are cooperatively disposed, dimensioned and configured to be telescopically received into a correspondingly dimensioned and/or configured space of the hollow interior 14.

In at least one embodiment, the plurality of fingers 30-32 secured to the inner surface of the end cap 28, includes one of the plurality of three fingers, as at 30, dimensioned and configured to be telescopically received within an open space 34 of the hollow interior 14 located adjacent to the connector cavity 19. In cooperation therewith, two others of the plurality of engaging fingers, as at 31 and 32, are disposed in spaced relation to one another at generally an upper end of the end cap 28. Being so disposed, each of the engaging fingers 31 and 32 are angularly or otherwise oriented to be telescopically received within different ones of the receiving cavities 20. It is emphasized that the number, disposition, dimension and configuration of the plurality of fingers associated with the end cap 28 may vary and still be considered within the spirit and scope of the present invention. In order to assure a fixed, stable but removable attachment of the end cap 28 to one of the open ends 12″ of the base 12, a separate connector 26, such as a screw or the like, passes through an appropriate aperture 27 in the end cap 28 and into the aforementioned connector cavity 19. As a result, the connector 26 may be removably threaded or otherwise removably mate with interior surface portions of the connector cavity 19.

Therefore, the bottom rail 10 includes a base 12 with a preferred elongated elliptical shape, having a hollow interior 14 including a plurality of collectively symmetrical cavities 18-20, all cooperatively structured to facilitate attachment to the free end 102 of a shade 100 in a plurality of different operative orientations, methods, styles, etc. as represented in FIGS. 4-6.

More specifically, with initial reference to FIG. 4 the plurality of operative orientations may include an external, exposed orientation. Accordingly the operative orientation of FIG. 4 comprises the distal end 102 of the shade 100 passing into the interior 14 of the base 12 through the elongated opening 16, wherein it is secured by the retaining rod 24′.

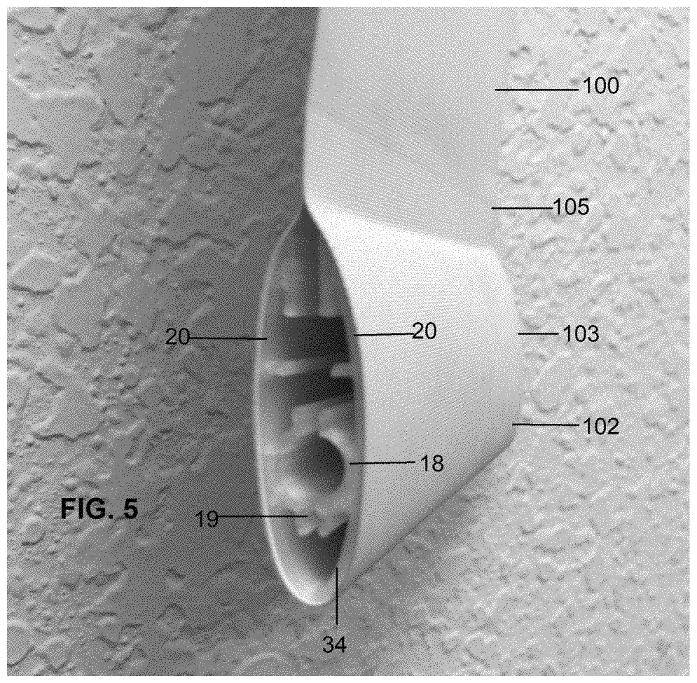

With reference to FIG. 5, the operative orientation, style, method etc. of the bottom rail 10 comprises an enclosed, hem bar orientation at least partially defined by the bottom rail 10 disposed within a pocket or channel 103 formed by the free end 102 being welded or otherwise connected, as at 105, to a remainder of the shade 100.

With reference to FIG. 6, the bottom rail 10 comprises a covered, wrapped orientation, method, style, etc. at least partially defined by the extremity 102′ of the free end 102 of the shade 100 passing into the hollow interior and being retained within one of the receiving cavities 20, as represented. A remainder of the free end 102 and/or contiguous portion of the shade 100 is retained by the retaining rod 24′ and extends outwardly through the elongated opening 16 in surrounding, wrapped, covering relation to the exterior of the base 12.

Each end cap 28 may be attached in the manner indicated to the base 12 of the bottom rail 10, dependent at least in part, on the operative orientation of the base 12 and bottom rail 10 when connected to the free end 102 of the shade 100, as set forth in greater detail above. Accordingly, it is to be noted that in the operative orientation of the bottom rail 10, as represented in FIG. 4, one or more of the end caps 28 may be connected in the manner described above to a corresponding open end 12″ of the base 12. In contrast, end caps 28 may or may not be connected to the base 12, when the bottom rail 10 assumes the enclosed or covered operative orientations of FIGS. 5 and 6.

Therefore, the versatile operative and structural features of the bottom rail 10 of the present invention serves to overcome disadvantages associated with conventionally structured and designed bottom rails, by allowing the bottom rail 10 to assume anyone of a plurality of different operative orientations, when connected to the free end 102 of the shade 100 such as represented in, but not limited to, the operative orientations, methods, styles, etc. of FIGS. 4-6.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A bottom rail for a flexible material shade, said bottom rail comprising:
an elongated base dimensioned and configured to be connected to a free end of the shade,
said base including a hollow interior extending along the length of said base,
said hollow interior comprising a plurality of cavities,
said plurality of cavities including a retainer cavity and a connector cavity, and
said retainer and connector cavities including interiors disposed in segregated relation to one another.

2. The bottom rail as recited in claim 1 wherein said retainer cavity is structured to receive a retainer therein, in retaining engagement with the free end of the shade.

3. The bottom rail as recited in claim 2 wherein said retainer cavity extends along at least a majority of the length of said base.

4. The bottom rail as recited in claim 2 wherein said retainer comprises an elongated rod comprising a weighted construction.

5. The bottom rail as recited in claim 1 wherein said connector cavity is structured to receive a connector therein.

6. The bottom rail as recited in claim 1 wherein said plurality of cavities further include at least one receiving cavity disposed and configured to receive and retain the free end of the shade therein.

7. The bottom rail as recited in claim 1 further comprising an elongated opening formed in an outer periphery of said base and extending along an entirety of the length thereof.

8. The bottom rail as recited in claim 7 wherein said elongated opening is disposed in communication with said hollow interior and dimensioned to receive the free end of the shade there through.

9. The bottom rail as recited in claim 8 wherein at least one of said plurality of cavities is disposed in receiving relation to the free end of the shade passing through said elongated opening.

10. The bottom rail as recited in claim 1 wherein said plurality of cavities are collectively disposed in a symmetrical orientation relative to a major axis of said hollow interior.

11. The bottom rail as recited in claim 10 wherein said plurality of cavities include two receiving cavities equally disposed in spaced relation to said major axis on opposite sides thereof.

12. The bottom rail as recited in claim 10 wherein said major axis passage concurrently and equally through at least some of said plurality of cavities (through said retainer cavity and said connector cavity).

13. The bottom rails recited in claim 12 wherein a transverse section of said base and said hollow interior comprises an elongated elliptical configuration.

14. The bottom rail as recited in claim 13 wherein a major axis of said elliptical configuration passes through at least one of said plurality of cavities.

15. The bottom rail as recited in claim 1 further comprising an end cap structured for attached, overlying disposition to an open end of said base.

16. The bottom rail as recited in claim 15 wherein said end cap comprises a plurality of fingers extending outwardly there from into correspondingly dimensioned ones of said plurality of spacings or cavities of said hollow interior, concurrent to said attached, overlying disposition.

17. The bottom rail as recited in claim 15 further comprising a connector extending through said end cap in attachment with an interior of said connector cavity, concurrent to said attached, overlying disposition.

18. The bottom rail as recited in claim 1 wherein said base, said hollow interior and said plurality of cavities are cooperatively structured for attachment to the free end of said shade in a plurality of different operative orientations.

19. The bottom rail as recited in claim 18 wherein said plurality of different operative orientations include an external, exposed orientation.

20. The bottom rail as recited in claim 19 wherein said plurality of different operative orientations include an enclosed hem bar orientation.

21. The bottom rail as recited in claim 20 wherein said plurality of different operative orientations include a covered, wrapped orientation.

22. The bottom rail as recited in claim 1 wherein the bottom rail comprises a bottom rail hem bar.
